(19) United States
(12) Patent Application Publication
(10) Pub. No.: US 2014/0186644 A1
(43) Pub. Date: Jul. 3, 2014

(54) MOISTURE RESISTANT COATING

(71) Applicants: David A. Dellinger, Santa Barbara, CA (US); Elie Helou, JR., Santa Barbara, CA (US); Drew V. Speer, Simpsonville, SC (US); Dwight W. Schwark, Simpsonville, SC (US)

(72) Inventors: David A. Dellinger, Santa Barbara, CA (US); Elie Helou, JR., Santa Barbara, CA (US); Drew V. Speer, Simpsonville, SC (US); Dwight W. Schwark, Simpsonville, SC (US)

(21) Appl. No.: 13/740,025

(22) Filed: Jan. 11, 2013

Related U.S. Application Data
(60) Provisional application No. 61/747,955, filed on Dec. 31, 2012.

(51) Int. Cl. C09D 101/10; B32B 29/06

(52) U.S. Cl. CPC C09D 101/10; B32B 29/06
USPC 428/535; 106/170.21

(57) ABSTRACT

Some embodiments of the invention generally relate to a moisture barrier coating that is biodegradable and compostable. Some embodiments also relate to a coating that is dual ovenable. Such coatings may be used to increase moisture resistance and provide non-stick or release characteristics when applied to biodegradable and compostable disposable food packaging and food service items. In some embodiments, a plasticizer or an amide wax are added to a cellulose-ester, shellac, and rosin based coating to increase moisture resistance and reduce brittleness. In other embodiments, phospholipids or medium-chain triglycerides or increased levels of amide wax may be added to the either of the embodiments above to provide enhanced release characteristics.

### CROSS REFERENCE TO RELATED APPLICATIONS

This application claims the benefit of U.S. Provisional Patent Application No. 61/747,955, filed Dec. 31, 2012 which is incorporated herein by reference.

### BACKGROUND

Plastic and paper pollution are reaching epidemic levels, polluting our oceans and quickly filling our available landfill capacities. Conventional disposable food packaging and food service items are an example of this pollution. They are commonly made from paper or paperboard which is coated, impregnated, or laminated with a polymeric waterproofing material such as wax, polyethylene, or a polyester film or made from one of a variety of plastics (polystyrene is the most common). These materials have good to excellent resistance to moisture, can be insulating (e.g., foamed polystyrene or “Styrofoam”), and are inexpensive and durable. In addition, ovenable disposables are made from aluminum or CPET, commonly known as dual ovenable plastic.

The current drive by many countries to reach industrial status has greatly reduced the free time that its working population has for preparing food at home or for creating specialty items. As this trend continues to accelerate, the demand for disposable packaging is growing exponentially. Moreover, there is a growing recognition that the environmental costs (from production through disposal) of using these “cheap” materials may be quite high compared to natural products that are biodegradable and/or compostable. The expected lifetime of a polystyrene cup, for example, can be up to 500 years, and each American disposes an average of about 100 of these cups per year. Further, polystyrene is made by chemical processing of benzene and ethylene, both byproducts of a petroleum industry that is recognized for its environmental problems. While governments around the world have all but given up on implementing recycling programs as unworkable and too costly, they still have the problem of garbage accumulation to solve and many have started taxing non-degradable packaging. There is a need to address environmental concerns with respect to disposable food service and food packaging items.

The biggest challenge in making durable, disposable food service and packaging articles that address the environmental concerns discussed above is an inherent lack of moisture resistance. All biological processes that result in the degradation of organic materials rely upon water to function. As a result, it is very difficult to make a material highly moisture resistant that will also be biodegradable and compostable.

One method currently used to address environmental concerns about conventional disposable food container products is the manufacture of starch and/or cellulosic-based disposable food service items such as trays, plates, and bowls. Many starch and/or cellulosic-based packaging materials have several drawbacks, the most important being that the containers are susceptible to water. Cooked, unmodified starch is typically water soluble. Because all of the starch-based biodegradable food service items currently being manufactured are formed in heated molds, much or all of the starch in these items is cooked, and the products thus formed are sensitive to moisture. Cellulose fiber (e.g., paper and paperboard or pulp) and cellulose derivatives (e.g., cellophane and cellulose esters, ethers, etc.) are also quite permeable to water. When exposed to water, other aqueous fluids, or significant amounts of water vapor, these items may become very soft, losing form-stability and becoming susceptible to puncture by cutlery (e.g., knives and forks).

Improvements to starch and/or cellulosic-based biodegradable articles may be made to make them more moisture resistant. Improvements may also serve to strengthen the matrix material by enhancing the chemical and physical properties, and include the addition of wax or wax emulsions, fiber sizing agents, plasticizers, polymers, or a combination thereof. These articles perform the best under low-moisture conditions in food and non-food applications alike. Examples of said biodegradable containers are found in U.S. Pat. No. 7,553,363, granted Jun. 30, 2009; U.S. patent application Ser. No. 11/285,508, filed Nov. 21, 2005; U.S. patent application Ser. No. 12/168,049, filed Jul. 3, 2008; and U.S. patent application Ser. No. 12/257,289, filed Oct. 23, 2008, which, by reference, are incorporated herein in their entirety.

Some applications require further increased moisture resistance. For example, some convenience foods and drinks that require the addition of hot or boiling water such as soups or instant coffee must have a container that is more capable of resisting moisture absorption than a plate that is being used to heat solid food, such as a piece of leftover chicken. Further examples of the type of demanding applications that may require increased moisture resistance are pre-made, ready to eat meals for schools, prisons and other institutions, bakery items, frozen or refrigerated prepared meals, soup and noodle bowls, cups for coffee, hot chocolate, and other beverages, cereal bowls, ice cream and yogurt cups, and other similar high-moisture applications. One way to improve to the moisture resistance of various biodegradable materials is by applying a coating to the product. In addition to moisture resistance, some applications require non-stick or release characteristics. Such applications include bakery items, for example, pies, breads, muffins, pizza, cakes and the like.

In keeping with the desire to produce biodegradable and compostable containers, it is also desirable for a coating that increases the moisture resistance to be biodegradable and compostable. Cellulose esters can be biodegradable depending upon the degree of substitution and are known in the art as base polymers used in coatings and inks By themselves, cellulose esters have a very high moisture vapor transmission rate (MVTR) and thus offer only short term resistance to water.

A coating that has moisture resistance sufficient for high-moisture applications as described above, as well as economically efficient and completely biodegradable and compostable has yet to be perfected.

It is therefore an object of some embodiments of the present invention to provide a fully biodegradable and compostable coating with improved moisture resistance such that the Moisture Vapor Transmission Rate (MVTR) is significantly reduced, thus allowing use in high moisture applications.

It is further an object of some embodiments of the present invention comprising wax to reduce or eliminate the need to coat food service or packaging items at elevated temperatures or to expose such items to prolonged drying/heating above the melting point of the wax in order to obtain the lowest MVTR.

It is a further object of some embodiments of the present invention to provide a highly moisture-resistant coating that is also cost-effective.

It is a further an object of some embodiments of the present invention to provide a highly moisture-resistant coating that is dual ovenable, heat sealable, and which provides product release in bakery applications.

### SUMMARY

Embodiments of the present invention provide novel formulations for biodegradable and compostable coatings with increased moisture resistance, suited for use on various highly absorbent and/or permeable substrates. One embodiment provides a biodegradable and compostable coating for biodegradable and compostable disposable items that can serve as functional food packaging and/or food service items for high-moisture applications. Such applications may, for example, include ice cream and other frozen dessert products; pre-made, ready-to-eat fresh or frozen prepared meals; soup and/or noodles; coffee, hot chocolate and other beverages; cereal; yogurt; baked goods such as cakes, muffins, cookies, and breads; fruit, meat and vegetable pies; pizza pies, candy products; and other high-moisture products designed to be eaten by humans or animals. Another embodiment provides a biodegradable and compostable coating for biodegradable and compostable disposable items that is dual ovenable (i.e., may be used in both microwave and conventional ovens) and offers improved product release in bakery applications. Another embodiment provides a biodegradable and compostable coating for biodegradable and compostable disposable items that is heat sealable. Another embodiment provides a biodegradable and compostable coating with improved moisture resistance in order to allow biodegradable and compostable disposable items to be used in high moisture applications. Another embodiment provides method of manufacturing a biodegradable and compostable coating for biodegradable and compostable disposable items that has improved moisture resistance. Other embodiments comprising a wax provide a method of coating biodegradable and compostable disposable items such that the improved moisture barrier property is obtained without the need to coat at elevated temperature or prolonged drying or heating above the melting point of the wax.

Other features and advantages of the present invention will become apparent from the following detailed description. It should be understood, however, that the detailed description and the specific examples, while indicating the preferred embodiments of the present invention, are given by way of illustration only, since various changes and modifications within the spirit and scope of the present invention will become apparent to those skilled in the art from this detailed description.

### DETAILED DESCRIPTION

In order to fully understand the manner in which the above-recited details and other advantages and objects according to the invention are obtained, a more detailed description of the invention will be rendered by reference to specific embodiments thereof.

In one embodiment, a biodegradable and compostable coating may be applied to biodegradable and compostable disposable articles such that it partially or completely permeates the outer and/or inner surface of the item or items, improving water resistance and heat seal properties of the container.

The coating may be applied to an article using any means known in the art of coating paper, paperboard, plastic, film, polystyrene, sheet metal, glass or other packaging materials, including spray, blade, puddle, air-knife, printing, Dahlgren, gravure, curtain, dip and powder coating. Coatings may also be applied by spraying the article with a biodegradable and compostable coating formulation or dipping the article into a vat containing a biodegradable and compostable coating formulation or passing the article through a curtain of the coating formulation as described by any of the embodiments of the present invention. Multiple coatings may be applied by one or more methods used together. For example, a first or primer coat may be applied by a suitable method followed by a second or top coat applied by another method. The article may or may not be dried between the steps. The apparatus used to coat the articles will depend on the shape of the article. For example, flat articles may be coated differently than cups, bowls and the like.

Depending on the selection of ingredients below, some embodiments are dual ovenable and/or heat sealable and may include product release properties in bakery applications.

One formulation according to an embodiment of the present invention from which a biodegradable and compostable coating for biodegradable and compostable disposable items can be made provides for a cellulose ester, shellac, and rosin.

Another formulation according to an embodiment of the present invention from which a biodegradable and compostable coating can be made provides for a cellulose ester, shellac, rosin, and a wax.

Another formulation according to an embodiment of the present invention from which a biodegradable and compostable coating can be made provides for a cellulose ester, shellac, rosin, and one or more plasticizers.

Another formulation according to an embodiment of the present invention from which a biodegradable and compostable coating can be made provides for a cellulose ester, rosin, and one or more waxes.

Another formulation according to an embodiment of the present invention from which a biodegradable and compostable coating can be made provides for a cellulose ester, shellac, rosin, and one or more release agents,

### Cellulose Esters

Various types of cellulose esters can be used as a base for a biodegradable and compostable coating. Preferred cellulose esters used in some embodiments of the present invention include cellulose acetate propionate (CAP), cellulose acetate butyrate (CAB), cellulose acetate (CA), and nitrocellulose (NC). In some embodiments where an ovenable coating is desired the preferred cellulose esters are CAP, CAB, and CA. For rapid biodegradability the preferred degree of substitution (D.S.) is less than about 2.2.

### Shellac

Shellac is a hard amorphous resin produced by insects (kerria lacca) as a protective covering for their larvae. It is a material of natural origin that finds applications in fruit and vegetable coating, confectionary coating, leather finishes and extensively in wood coatings. The natural resin is typically refined by bleaching to produce a lighter colored material. Shellac contains a natural wax that may or may not be removed depending upon the application. By itself, shellac has only moderate resistance to water. The preferred shellac of the present invention is bleached and retains the naturally occurring wax.

### Rosin

Generally, any rosin or modified rosin may be used with the coating, although it is preferred to use natural rosin that has not been modified. Rosin has been found to surprisingly improve the moisture resistance of cellulose-ester/shellac based coating. Further it is believed to improve the adhesion of the coating to the substrate and to any additional films or coatings adhered to the moisture resistant coating layer. In some embodiments, the concentration of rosin in the coating is about 0% to about 50%, or about 0% to about 35%, or about 0% to 20% of the dry weight of the formulation.

### Solvent

The coating is preferably solvent borne when the substrate to be coated is sensitive to the effects of water. Suitable solvents include methyl acetate, ethyl acetate, propyl acetate, ethanol, propanol, butanol, acetone, methyl ethyl ketone, minor amounts of water, hydrocarbons and the like in various proportions as required for solubility and coatability of the ingredients. It is preferred that the solvents be selected from those not considered to be hazardous air pollutants (HAP) and be obtainable from non-petroleum sources. Especially preferred non-HAPS solvents are acetone, ethanol, ethyl acetate, methyl acetate, and methyl ethyl ketone. Acetone and methyl acetate are also preferred because they are typically exempt from volatile organic compound (VOC) regulations.

### Waxes

Waxes are used to improve moisture resistance in biodegradable products, to reduce the coating's coefficient of friction, to reduce brittleness of the coating, and also to provide some release characteristics to the coating. Typical waxes for such use are, for example, carnauba, candelilla, beeswax, and paraffin. However, in the prior art cellulose ester barrier coatings that include wax have generally relied upon coating and/or drying above the melting point of the wax in order to obtain the greatest moisture barrier property. In some embodiments of the current invention, the use of soluble amide waxes was found to improve the moisture barrier property of the coating by a factor of 30 to 40% and to obviate the need to coat and/or dry the coating above the melting point of the wax in order to obtain the best moisture barrier. In other embodiments of the current invention, the use of soluble amide waxes was found to reduce the propensity of the coating to crack. While various waxes may be used, it is desirable to use solvent-soluble amide waxes, not only for their moisture-resistance properties, but because they are less expensive than waxes like carnauba. Examples include oleamide, stearamide, erucamide, oleyl palmitamide, N,N′-ethylene-bis-stearamide and the like. In particular it is desired to use N,N′-ethylene-bis-oleamide, and especially oleamide. These soluble amide waxes, and to a lesser degree stearamide-based waxes are soluble in non-HAPS (hazardous air pollutant) ester/alcohol/ketone and hydrocarbon solvent blends that are advantageously used in these coatings. In some embodiments, the concentration of wax in the coating is about 0% to about 15%, about 2% to about 10%, or about 3% to about 8% of the dry weight of the formulation.

### Plasticizers

The plasticizer used with these coatings should be environmentally friendly, e.g., inherently biodegradable and/or natural and/or based on bioderived carbon compounds. It is preferred to choose a plasticizer that promotes biodegradation, as some plasticizers may cause undesirable slowing of biodegradation. Thus, the preferred plasticizers for use with this invention are citric acid esters such as triethyl citrate, tributyl citrate, and acetylated tributyl citrate, triacetin (glycerol triacetate), and tributyrin (glycerol tributyrate) and epoxidized soybean oil (ESO). Especially preferred is triacetin since it is generally regarded as safe (GRAS) in the United States and European Union. In some embodiments, the concentration of plasticizer in the coating is about 0% to about 30%, about 1% to about 10%, or more preferably about 4% to 8% of the dry weight of the formulation.

### Release Agents

When it is desirable for the coating to provide superior release properties as in, for example, bakery applications (pies, breads, muffins, cakes, and the like), it is advantageous to incorporate one or more release agents. Suitable release agents include phospholipids such as lecithin and phosphated mono and diglycerides, polydimethylsiloxane, and triglycerides. In addition to providing release, triglycerides can also act as a carrier for lecithin. In an application in which miscibility in alcohol solvents is desired, medium chain triglycerides (MCT) may be used. Medium chain triglycerides are defined as having fatty acids of 6-12 carbon atoms esterified with glycerol.

### Comparative Examples

### Base Moisture Resistance Performance of Cellulose-Ester, Shellac and Rosin

MVTR values were determined by covering a water-containing cell with a thin film of the sample material supported on a biodegradable substrate such as paper or Biosphere Industries starch/fiber tray material designated as PPM 100 (Biosphere 18P008 10 inch tart pan), placing the cell into an environment with controlled temperature, then measuring the weight of liquid water lost (g) from the cell through a fixed surface area (m²) in a specific time period (days). The values may be normalized to a substrate with a thickness of 1 mil (0.001 inch). For these experiments, the temperature of the cell was held either at 40° C. (100% RH inside, ambient RH outside) or at 23° C. (100% RH inside, 50% RH outside). ASTM E96/E 96M-05 describes Standard Test Methods for Water Vapor Transmission of Materials. A decrease in the MVTR indicates an increase in the moisture barrier properties of the coating formulation.

TABLE 1

| | Conditions | | |
|---|---|---|---|
| | 1 = 40° C. | MVTR ± S.D. | |
| Sample | 2 = 23° C. | (g-mil/m²-day) | Category |
| Biosphere PPM100 | 1 | 93700 ± 2300 | comparative |
| (uncoated 18P008) | | | |
| Biosphere PPM100 | 2 | 49000 ± 1700 | comparative |
| (uncoated 18P008) | | | |
| coated with 12 g/m² CAP504 | 1 | 109000 ± 8500 | comparative |
| Coated with 12 g/m² Shellac | 1 | 79000 ± 5600 | comparative |
| with 15% Rosin1? | | | |

Legend:

| Code | Full Name | Composition Type |
|---|---|---|
| Shellac | Regular bleached shellac | Shellac |
| CAP504 | CAP504-0.2 cellulose acetate | Cellulose ester |
| | propionate | |
| Triacetin | Triacetin | Plasticizer |
| A4 | Citroflex ® A-4 acetyl tributyl | Plasticizer |
| | citrate | |
| ESO | Epoxidized soybean oil | Plasticizer |
| Oleamide | Kemamide VO, Oleamide | Amide Wax |
| EBS | Microspersion 528 (dispersion of N,N′- | N,N′-ethylene-bis- |
| | ethylene-bis-stearamide in water) | stearamide Wax |
| Rosin1 | Pexite WG | Natural rosin |
| Rosin2 | Sylvaros NCY | Natural rosin |

A standard test to measure the water absorption of paper and paperboard is known as the Cobb Test (see ASTM D 3285-93). Cobb tests are conducted for a set period of time such as 2 minutes or 20 minutes after which the absorption of water is measured gravimetrically on a known area of material. An even more stringent test is conducted for 20 minutes with hot water. Table 2 shows a summary of Cobb tests for coated and uncoated starch/fiber based trays. The trays were designated Biosphere 18P008 (PPM100 material, 10 inch tart pan). Coatings were applied to the trays using a Nordson airless liquid spray system.

TABLE 2
Water Absorptiveness of 18P008 Tart Pans
Using the Cobb Test method

| | Dry | 20 Minute Cobb | |
|---|---|---|---|
| | Application | Value Hot | |
| Coating | Weight (g/m²) | Water^{a} (g/m²) | Std. Dev. |
| None | n/a | 290.3 | 18.9 |
| Shellac | 12 | 79.4 | 10.4 |
| Rosin1 | 16 | 66.6 | 10.2 |
| Shellac/Rosin1 (1/1) | 12 | 52.1 | 10.2 |
| CAP504 | 13 | 48.9 | 14.9 |
| CAP504/Shellac (4/1) | 14 | 67.9 | 17.0 |

^{a}Initial water temperature 180° F.

The data in Table 2 shows that the individual components of the preferred coatings provide only modest reduction in the water up-take of an absorbent substrate such as a starch/fiber tray. The combination of shellac and rosin is perhaps slightly better than either shellac or rosin alone, whereas, the combination of CAP and shellac is worse than CAP alone, but perhaps better than just shellac.

### Examples 1-9

A design of experiments was carried out to explore the three component mixture of CAP504, Shellac and Rosin1. Coating solutions were prepared using a 40% solution of regular bleached shellac in 95% denatured ethanol (duplicating fluid #5) and 5% water. The CAP and Rosin1 were dissolved in either ethanol or acetone and mixed with the Shellac. All solutions were 33.33% acetone with the balance of the solvent being denatured ethanol and water. The solids content of the solutions was either 20 or 25% and was chosen to keep the solution viscosities about the same. Table 3 summarizes the coating solutions.

TABLE 3
CAP/shellac/rosin Coating Solutions

| | Solids Composition | | | Solids | Viscosity |
|---|---|---|---|---|---|
| Example # | CAP504 | Shellac | Rosin1 | Content (%) | (cPs)^{a} |
| 1 | 0.40 | 0.40 | 0.2 | 25 | 37.1 |
| 2 | 0.55 | 0.25 | 0.2 | 20 | 27.2 |
| 3 | 0.25 | 0.60 | 0.15 | 25 | 25.4 |
| 4 | 0.65 | 0.25 | 0.10 | 20 | 43.4 |
| 5 | 0.60 | 0.25 | 0.15 | 20 | 33.4 |
| 6 | 0.45 | 0.45 | 0.10 | 25 | 55.4 |
| 7 | 0.25 | 0.55 | 0.20 | 25 | 22.9 |
| 8 | 0.425 | 0.425 | 0.15 | 25 | 46.4 |
| 9 | 0.25 | 0.65 | 0.10 | 25 | 27.0 |

^{a}Brookfield LVTDV-II, 25° C., #18 spindle 13R samples adaptor.

A Nordson airless spray system was used to coat Biosphere 18P008 starch trays (PPM100 material, 10″ tart pans). The coating was dried at 80° C. for 2 minutes resulting in a dry coating weight of 15 g/m². The 20 minute hot water Cobb values and MVTR (23° C., 100% RH in, 50% RH out) were determined as described above and are shown in Table 4.

TABLE 4
Cobb Values and Moisture Vapor Permeability

| | Cobb Value | | MVTR | |
|---|---|---|---|---|
| Example | (g/m²) | Std. Dev. | (g-mil/m² · day) | Std. Dev. |
| 1 | 11.96 | 1.72 | 19,700 | 1700 |
| 2 | 10.23 | 0.45 | 23,900 | 1280 |
| 3 | 64.66 | 3.23 | 37,800 | 157 |
| 4 | 18.60 | 1.24 | 28,000 | 1520 |
| 5 | 10.27 | 1.08 | 27,100 | 4780 |
| 6 | 8.67 | 1.90 | 27,200 | 1730 |
| 7 | 70.14 | 17.16 | 35,200 | 5350 |
| 8 | 11.81 | 0.74 | 28,000 | 3360 |
| 9 | 48.15 | 7.57 | 40,900 | 3390 |

The data in Table 4 show a wide range of performance across this compositional range. The best overall performance seems to be in the range of 40-65% CAP504, 25-45% Shellac (solids), and 10-20% Rosin1. Within these ranges, this three component blend is surprisingly synergistic with respect to moisture resistance as compared to the individual components.

### Example 10

To the coating solution from Example 2 was added 6% oleamide wax (solids basis) and the solution was spayed, dried and tested as above. The 20 minute hot water Cobb value was found to be 12.18 (std. dev. 1.77) and the MVTR was 16,300 (std. dev. 1900). It was noted that upon microwave cooking of tomato sauce in the coated tray, this coating had fewer cracks than coatings without the added oleamide.

### Example 11

To the coating solution from Example 6 was added 6% oleamide wax (solids basis) and the solution was spayed, dried and tested as above. The 20 minute hot water Cobb value was found to be 19.48 (std. dev. 2.49) and the MVTR was 16,300 (std. dev. 559). It was noted that upon microwave cooking of tomato sauce in the coated tray, this coating had fewer cracks than coatings without the added oleamide.

### Example 12

A coating solution was prepared and coated as above except that the solids composition was 54% CAP504, 28% Shellac, and 18% Rosin1. The 20 minute hot water Cobb value was found to be 13.06 (std. dev. 2.24) and the MVTR was 19,700 (std. dev. 2400).

### Example 13

To the coating solution of example 12 was added oleamide wax (6% solids basis) and the solution was sprayed, dried and tested as above. The 20 minute hot water Cobb value was found to be 16.12 and the MVTR was 27,300 (std. dev. 2600). It was noted that upon microwave cooking of tomato sauce in the coated tray, this coating had fewer cracks than coatings without the added oleamide.

### Example 14

To the coating solution of example 12 was added epoxidized soy bean oil (ESO, 4.3% solids basis) and the solution was sprayed, dried and tested as above. The 20 minute hot water Cobb value was found to be 17.24 (std. dev. 2.78) and the MVTR was 26,200 (std. dev. 1480). It was noted that upon microwave cooking of tomato sauce in the coated tray, this coating had fewer cracks than coatings without the added ESO.

### Example 15

To the coating solution of example 12 was added Citroflex A-4 (4.3% solids basis) and the solution was sprayed, dried and tested as above. The 20 minute hot water Cobb value was found to be 16.09 (std. dev. 2.19) and the MVTR was 25,600 (std. dev. 589). It was noted that upon microwave cooking of tomato sauce in the coated tray, this coating had fewer cracks than coatings without the added A-4.

### Example 16

A coating solution was prepared as above except that the solids composition was 75.5% CAP504, 18.9% Rosin1, 2.8% oleamide wax, and 2.8% EBS wax (Ethylene bis stearamide); total solids content was reduced to 15.9% to maintain a suitable viscosity. For this formulation, the solvent composition was 52.8% EtOH (Duplicating Fluid 5), 46.1% acetone, and 1.1% water. The solution was sprayed, dried, and tested as in previous examples. The 20 minute hot water Cobb value was found to be 12.20 (std. dev. 1.20) and the MVTR was 35,800 (std. dev. 3310).

### Example 17

The coating solution of example 12 was coated onto copy paper (basis weight 75 g/m²) with a coating weight of 15 g/m². The uncoated paper had a 20 minute hot water Cobb value of 95.6 g/m² (std. dev. 1.8) and the MVTR was 10,200 g-mil/m²-day (std. dev. 918). The coated paper had a 20 min hot water Cobb value of 6.1 (std. dev. 0.2) and an MVTR of 2540 (std. dev. 108). These data clearly show the suitability of the coating for moisture resistance on paper.

### Example 18

The coating solution of example 12 was coated onto a manila folder (9 mil thick paperboard) with a dry coating weight of 15 g/m². The uncoated folder had a 20 minute hot water Cobb value of 263.6 g/m² (std. dev. 8.2) and the MVTR was 11,000 g-mil/m²-day (std. dev. 394). The coated paperboard had a 20 min hot water Cobb value of 20.9 (std. dev. 6.9) and an MVTR of 2630 (std. dev. 198). These data clearly show the suitability of the coating for moisture resistance on paperboard.

Although the invention has been described with respect to specific embodiments and examples, it will be readily appreciated by those skilled in the art that modifications and adaptations of the invention are possible without deviation from the spirit and scope of the invention. Accordingly, the scope of the present invention is limited only by the following claims.

What is claimed is:

1. A coating on a substrate comprising:
a cellulose ester,
a shellac; and
a rosin.

2. The coating of claim 1 further comprising a wax, a plasticizer, a release agent, or a combination thereof.

3. The coating of claim 2 wherein the cellulose ester comprises cellulose acetate propionate, cellulose acetate butyrate, cellulose acetate, or nitrocellulose; the shellac comprises regular bleached shellac; and the rosin comprises natural rosin.

4. The coating of claim 3 wherein the optional wax comprises oleamide, N,N′-ethylene-bis-oleamide, or N,N′-ethylene-bis-stearamide.

5. The coating of claim 3 wherein the optional plasticizer comprises a citric acid ester, triacetin, tributyrin, or epoxidized soybean oil.

6. The coating of claim 3 wherein the optional release agent comprises a phospholipid or a medium chain triglyceride.

7. The coating of claim 1 wherein the cellulose ester comprises cellulose acetate propionate, cellulose acetate butyrate, cellulose acetate, or nitrocellulose.

8. The coating of claim 1 wherein the shellac comprises regular bleached shellac.

9. The coating of claim 1 wherein the rosin comprises natural rosin.

10. The coating of claim 1 wherein the coating is biodegradable or compostable.

11. The coating of claim 1 wherein the substrate comprises starch, cellulose, a cellulose derivative, or PLA.

12. The coating of claim 1 wherein the substrate comprises paper, paper board, or a starch-based matrix containing paper or cellulose fibers.

13. A coating on a substrate comprising:
a cellulose ester,
a wax; and
a rosin.

14. The coating of claim 13 further comprising a plasticizer, a release agent, or a combination thereof.

15. The coating of claim 14 wherein the cellulose ester comprises cellulose acetate propionate, cellulose acetate butyrate, cellulose acetate, or nitrocellulose; and the rosin comprises natural rosin.

16. The coating of claim 15 wherein the plasticizer comprises a citric acid ester, triacetin, tributyrin, or epoxidized soybean oil.

17. The coating of claim 15 wherein the release agent comprises a phospholipid or a medium chain triglyceride.

18. The coating of claim 13 wherein the cellulose ester comprises cellulose acetate propionate, cellulose acetate butyrate, cellulose acetate, or nitrocellulose.

19. The coating of claim 13 wherein the wax comprises oleamide, N,N′-ethylene-bis-oleamide, or N,N′-ethylene-bis-stearamide.

20. The coating of claim 13 wherein the rosin comprises natural rosin.

21. The coating of claim 13 wherein the coating is biodegradable or compostable.

22. The coating of claim 13 wherein the substrate comprises starch, cellulose, a cellulose derivative, or PLA.

23. The coating of claim 13 wherein the substrate comprises paper, paper board, or a starch-based matrix containing paper or cellulose fibers.

24. A coating for application to a substrate comprising a cellulose ester, a shellac, a rosin, and a solvent, and optionally a wax, a plasticizer, or a release agent, wherein the solvent comprises methyl acetate, ethyl acetate, propyl acetate, butyl acetate, ethanol, propanol, acetone, water, or hydrocarbons.

25. A coating for application to a substrate comprising a cellulose ester, a wax, a rosin, and a solvent, and optionally a plasticizer or a release agent, wherein the solvent comprises methyl acetate, ethyl acetate, propyl acetate, butyl acetate, ethanol, propanol, acetone, water, or hydrocarbons.
